(19) United States
(12) Patent Application Publication
(10) Pub. No.: US 2018/0284511 A1
(43) Pub. Date: Oct. 4, 2018

(54) Variable Reflective Device With Internal Video Monitor

(71) Applicant: Rydeen North America, Inc., Torrance, CA (US)

(72) Inventor: Philip Maeda, Torrance, CA (US)

(21) Appl. No.: 15/477,300

(22) Filed: Apr. 3, 2017

(51) Int. Cl. G02F 1/133; G02F 1/135; B60R 1/12; B60R 1/00; B60R 1/08

(52) U.S. Cl. CPC G02F 1/13318; G02F 1/135; B60R 1/12; B60R 1/00; B60R 1/087; B60R 1/04; G02F 2203/02; G02F 2203/48; G02F 2001/13312; B60R 2001/1253; G02F 2001/1352

(57) ABSTRACT

A vehicle reflective device where the device reflectivity is adjustable by automatic or manual means, the variable reflectance element including a metallic mirror reflector on one side of a substrate. The variable reflectance function is automatically referenced to ambient light levels (day or night) and manually adjusted in response thereto. In an automatic mode, the variable reflectance assembly provides the user immediate eye protection from reflected high intensity glare by effecting near instantaneous adjustment in mirror reflectivity, such that the intensity of the reflected light impinging on the eye is automatically adjusted so as to be at comfortable levels. The mirror construction is one piece, and allows the viewing of a display monitor located behind the mirror, the mirror and monitor being operatively coupled together. In addition, the device houses a microprocessor that supports a number of software applications whose output is displayable on a designated portion of the device, the microprocessor also establishing a reflectance level within a relatively linear value of the ratio of glare light to ambient light to ensure that information displayed on the monitor screen is always available for viewing by the driver.

### BACKGROUND OF THE INVENTION

### 1. Field of the Invention

The present invention relates to a vehicle mirror system having a variable reflectance element with optionally selectable reflectance values and a rearward mounted viewable TFT LCD monitor for display a navigational map information, a reverse camera video image and a video image of items surrounding the vehicle such as front and side view cameras. The system allows the intensity of the monitor to be adjustable such that the balance between the eyes of the driver and the high beam from a vehicle in the rear to minimize driver discomfort.

### 2. Description of the Prior Art

Vehicle rearview mirrors which can automatically control the glare from bright lights of rearward sources, or glare from a rearward sun near the horizon, (sun rising or setting) have been available for some time. Methods for controlling the glare reflected in these mirrors have included use of mototized prismatic mirrors, utilization of liquid crystal shutters and also use of electro-optic medium elements, where the reflectivity of the mirror is controlled via an applied voltage initiated by light-sensors.

U.S. Pat. No. 8,717,521 issued to Philip Maeda discloses a reflective device wherein the device reflectivity is adjustable via automatic or manual means. The variable reflectance element includes a metallic mirror reflector on one side of a substrate and a liquid crystal or an electrochromic layer placed for achieving the, characteristics of variable reflectance. The minor assembly provides alternate trigger mechanisms for initiating the variable reflectance, the reflectance level being automatically referenced to ambient light levels (day or night) or manually adjusted or selected. In the automatic mode, the variable reflectance mirror assembly provides the user automatic eye protection from reflected high intensity glare by effecting near instantaneous adjustment in mirror reflectivity, such that the intensity of the reflected light impinging on the eye is automatically adjusted so as to be at comfortably viewable levels. The minor assembly construction is one piece, and allows viewing a display from the video monitor located adjacent to the mirror (independent of the operation thereof) when the vehicle is in reverse.

U.S. Pat. No. 9,319,639 issued to Englander et al on Apr. 19, 2016, discloses a rear-view mirror and modular monitor system useful in buses that includes an interior mirror that embeds a modular monitor behind see-through mirror glass. The system may include multiple cameras, some in the vehicle as well as some cameras outside the vehicle, providing the driver an opportunity to view what is happening, for example, in the back rows of the vehicle cabin, while also using the mirror to look at objects in the vehicle cabin that are visible using the mirror. However, the rearview reflectivity is not adjustable.

What is desired is to provide a vehicle rearview mirror assembly which incorporates a reflective element and a video monitor, the monitor being enveloped by the reflective element. The reflectivity of the mirror is controlled such that the monitor can be viewed in a manner to minimize driver discomfort and is always available to the viewer.

### SUMMARY OF THE INVENTION

The present invention provides a vehicle rearview mirror assembly having a variable reflective unit, or mirror, with short response times. Furthermore, numerical and graphical displays are viewed on a monitor located behind the mirror for user information and convenience. The mirror reflectance is adjustable by data input from cable, the data in turn being controlled by either a touch screen or a switch. A control for the reflectivity of a mirrored surface is provided which responds to the intensity or brightness of the light impinging on the minor from a rearward source, such as bright headlights from a following vehicle. The variable reflectance mirror system includes an electro-optic reflective element, sensor(s) of the ambient light level, sensor(s) of the glare light level condition, and a control circuit that responds to the current ambient and glare light levels which have been measured in order to control the reflectance level of the reflective element. The light sensors produce an output that is proportional to the light sensed by the glare and the ambient light sensors. A controller generates an output voltage amplitude (difference sensing function) level commensurate with the glare and ambient light levels sensed so that the monitor is viewable at night by the vehicle driver In particular, although the monitor is normally on at night, in order to compensate for light reflection from the headlights of a following vehicle (at night) or ambient light (during the day), the present system balances the light emanating from the monitor screen to minimize any discomfort to the viewer (driver).

The light sensor levels are measured sequentially so that errors due to component variations are minimized, allowing the use of mass-produced silicon sensors and avoids a costly effort to match components.

The present invention thus provides a variable reflectance mirror system incorporating a control that references the brightness of the rearward scene the mirror reflectivity being adjusted to maintain an appropriate and comfortable intensity level from the monitor shining into the viewer's eyes.

One section of the mirror device incorporates the monitor to view any video source, including backup camera view(s), navigational information, blind spot views and other display view(s), the entire mirror surface being used as a rearview mirror with adjustable reflectivity including the video display section.

The monitor display section is covered by the reflective device and thus the reflectance is controlled thereby allowing the video monitor to be seen when it is powered on to provide video information to the driver whether the vehicle is moving forward (drive mode) or backwards (reverse mode). During night time, when a driver needs to view navigation or other type of video information through the mirror, the restricted reflectance function is turned off.

The rearview mirror system is capable of carrying multiple inputs using different formats, such as HDMI, audio, video, USB, optical fiber etc. with an auto-switching function enabling multiple video sources to be displayed on the video display.

### DESCRIPTION OF THE DRAWINGS

For a better understanding of the present invention as well as other objects and further features thereof, reference is made to the following description which is to be read in conjunction with the accompanying drawing therein:

FIG. 1 illustrates the mirror assembly constructed in accordance with the teachings of the present invention;

FIG. 2 separately shows the front cover of the assembly shown in FIG. 1 with the power-on button;

FIG. 3 illustrates the reflective mirror element and back cover when separated;

FIG. 4 illustrates the monitor and internal plate when separated;

FIG. 5 is a view showing the PCB and main board when separated; and

FIG. 6 shows the back cover with a window for a light sensor that measures ambient light.

### DESCRIPTION OF THE INVENTION

The present invention pertains to a mirror assembly or multiple applications. More specifically, the present invention consists of a mirror assembly having a reflective element or mirror which integrates a number of electronic devices such as informational and symbolic graphical displays, displays of video and image data, light sensor or a monitor, the reflectance of the reflective element being controlled by automatic means or via the action of manual touch or manual switch settings.

To allow for light to be transmitted through the mirror element a portion of the reflective layer of the mirror element is removed to define a window in front of the electronic device, allowing informational, graphical, and video displays from a rear mounted monitor to be viewable to the user. A camera strategically situated on the vehicle with the image displayed to the user will aid the driver and provide enhanced security in backing up safely and other driving conditions. The invention provides options for display; for example the display may be presented to the user only when the vehicle transmission is in reverse, or it can supplement the mirror when driving.

An interior assembly consisting of a variable reflectance element is provided, the variable reflectance element including a special purpose optimized electro-optic element disposed between a first substrate and a second substrate, where the first substrate is contacted by the electro-optic medium on the interior side. The second substrate is contacted by a metallized minor reflector on the same side as the electro optic medium, the metallic minor reflector comprising a reflecting metal film formed of silver or a silver alloy. The mirror assembly additionally contains at least one light sensor and a control circuit. In response to a light level sensed by the light sensor, the mirror reflectance is adjusted by the control when the interior mirror assembly is operational. Mirror reflectance may be controlled by the light sensor system, by manual adjustment or by manual switch selection. Due to the one piece mirror construction, a video monitor or display is viewable from behind the mirror.

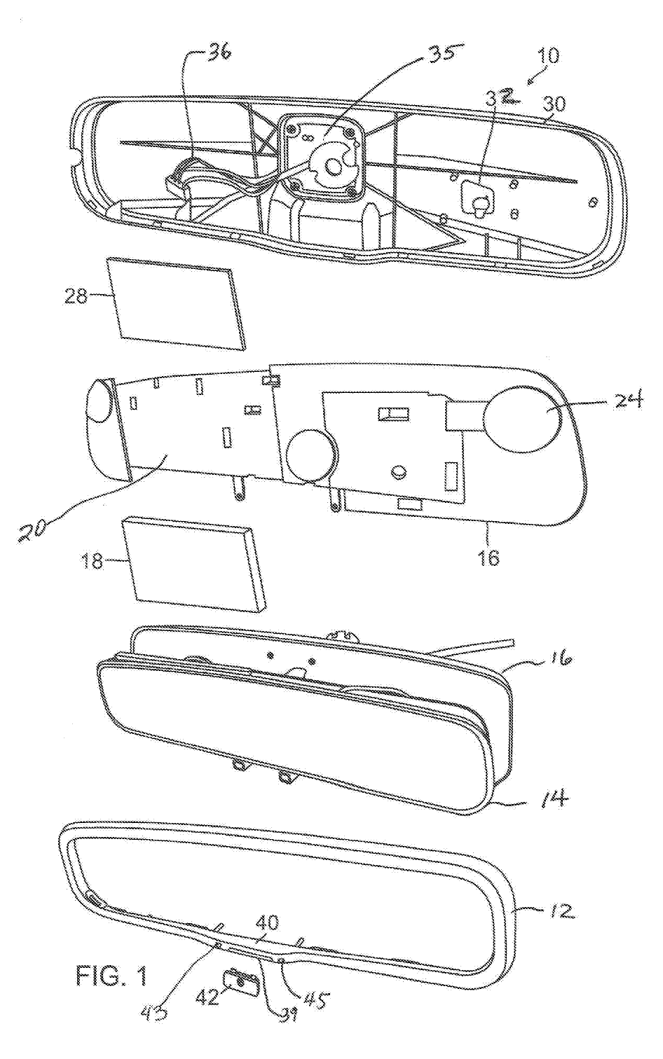

Referring specifically to FIG. 1, a view of the components which comprise the reflective mirror assembly 10 of the present invention is illustrated.

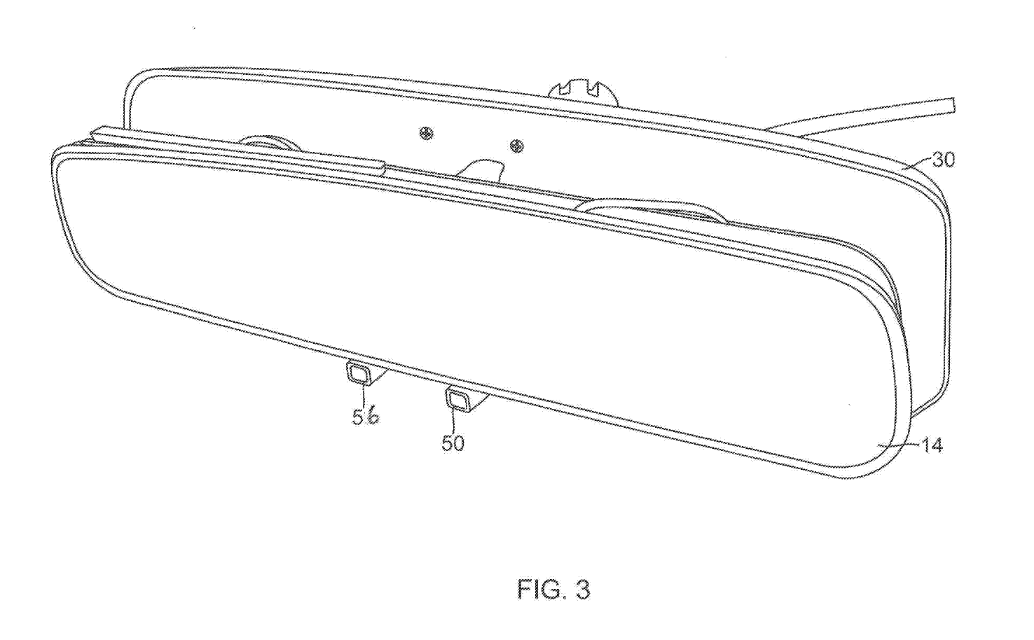

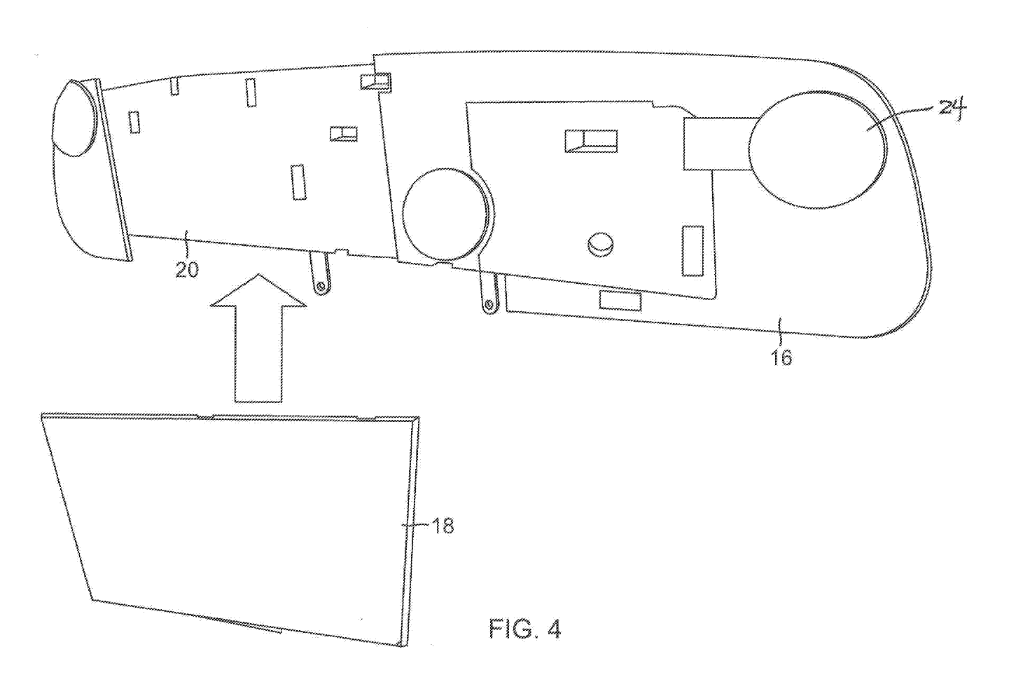

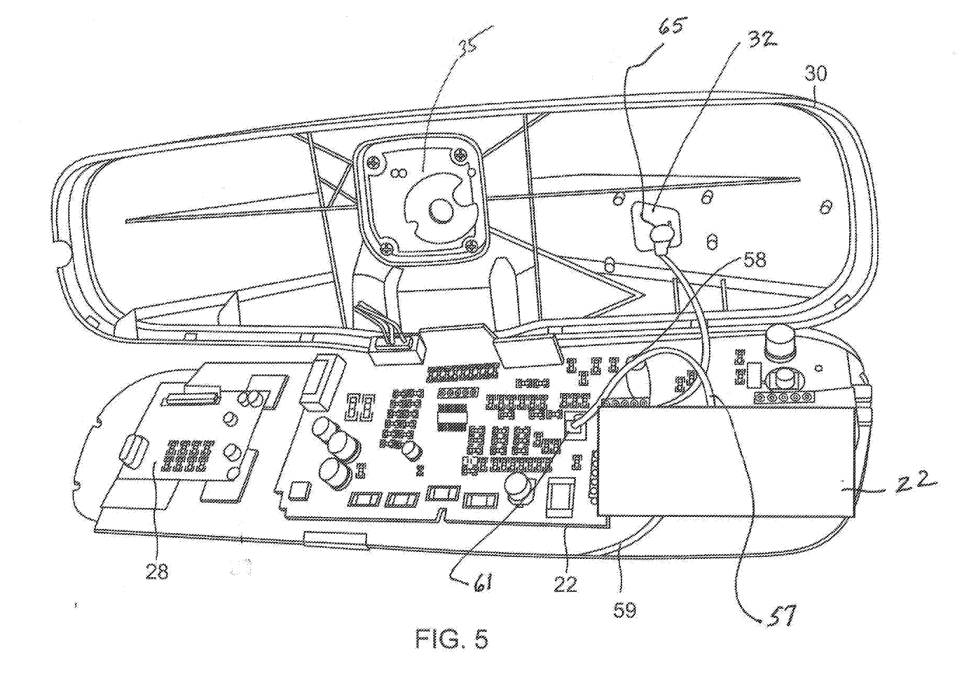

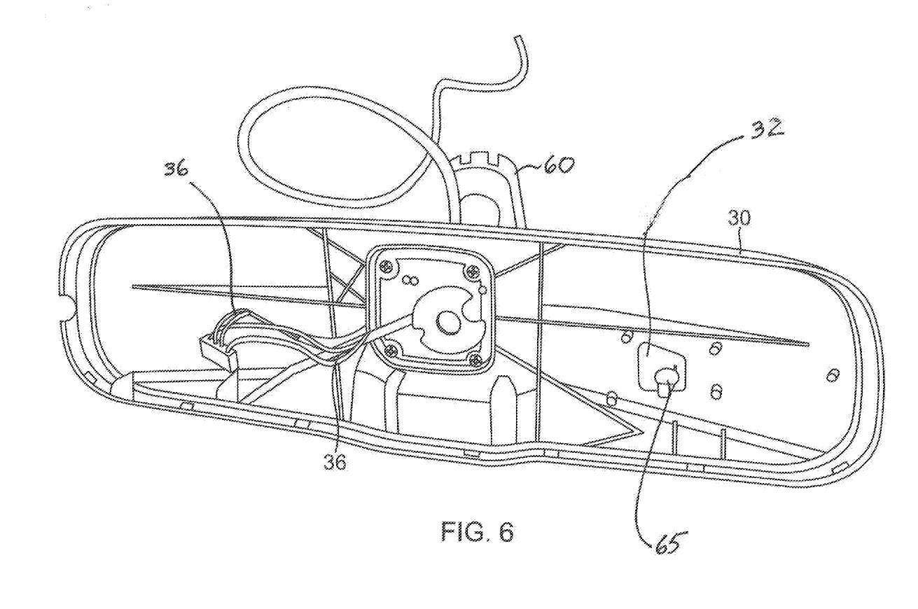

Specifically, component 12 is the frame element (front cover), having an opening, or recess, 40 to receive monitor function selection button 42, component 14 is a reflective mirror which, as shown in FIG. 3, extends essentially over the entire length of mirror assembly 10, component 16 is an internal frame (shown in FIG. 4) designed to hold, video monitor 18 in recess 20 formed in component 16, component 28 is a printed circuit board (“PCB”) which contains a mirror variable reflectance drive PCB 28 being mounted to the mar surface of structure 16, (see FIG. 5), an opening, or recess 24, for supporting a LED readout (not shown) and back cover 30 (FIGS. 5 and 6) having a window 34 to transmit ambient light to light sensor 58 (FIG. 5) and an opening 35 through which power and video cables 36 extend end then are connected to the appropriate system components. Note that currently available vehicle monitor products typically utilize 3.5 inch screen monitors; the structure of the present invention, on the other hand, is adapted to house a monitor with a 4.3 inch screen size which provides the driver with a larger and wider view.

Since the reflective element covers the entire rear surface of the mirror, it can be used in a traditional manner to see the rear of the vehicle when the monitor is not operating or is turned off.

The microprocessor is used to determine the reflective properties of the mirror in conjunction with the optical sensors.

The reflective element can be automatically controlled by the microprocessor (preferred method), adjusted manually using a setting within the circuit board or by a manual switch.

One layer of the reflective clement has a cutout portion in the display area. The mirror is still reflective but this allows light from the monitor to penetrate from behind a reflective coating so that the monitor can be viewed. When the monitor (screen) is off, the screen area still reflects as with a traditional mirror. The reflectivity in whole is controlled by the microprocessor for the entire reflective area of the mirror thus eliminating glare and undesirable effects of adverse lighting conditions.

Note that light sensor 56 responds both to ambient and reflected light from the headlights of a rearward traveling vehicle.

The ambient light received by both the front sensor 56 and rear sensor 58 determines a base point for lighting during the day or night. The ratio between the base point lighting and additional light sensors located at the rear side helps determine the desired reflective level for optimum operation.

The general camera (video source) and display (embedded in the rearview mirror) connection diagram is described in U.S. Pat. No. 9,434,316 issued to Philip Maeda on Sep. 6, 2016, the teachings of which are incorporated herein by reference. In essence, the '316 patent describes the preferred connection arrangement for delivering power and video to the mirror assembly 10, including monitor 18.

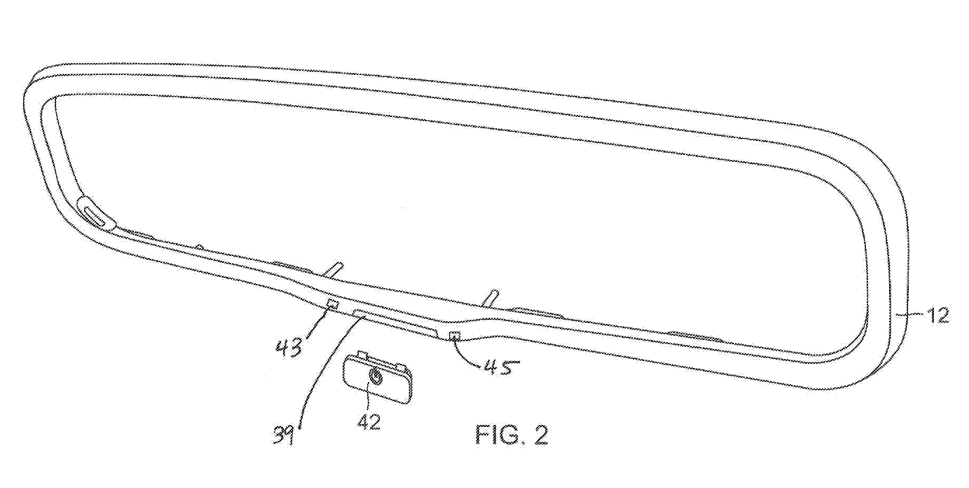

FIG. 2 illustrates in more detail front cover 12 and recess 39 for receiving button 42 bole (opening) 43 for the light sensor and hole (opening) 45 for the operating light to be viewed; FIG. 3 is a view of reflective mirror 14, front light sensor 56, on-off indicator light 50 and back cover 30.

FIG. 4 illustrates video display 18 ready to be secured in recess 20 formed in internal frame structure 16.

FIG. 5 illustrates back cover 30 with window 32 for allowing a rear light sensor 58 to receive ambient light. Also shown is monitor variable reflectance driver PCB 28, variable reflectance driver board 22 and connector 61, transparent connector 65 to couple received light to photosensor 58, cable 57 for connecting the output of sensor 58 to PCB 22 and cable 59 for connecting the output of PCB 22 to the mirror to control reflectivity.

FIG. 6 is a view showing back cover 30, wires 36 and window 32 (a stem 60 is for mounting the reflective device 10 to the front window of a vehicle is illustrated but does not form a part of the present invention).

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

1. A vehicle mirror assembly having an interior portion and a variable reflectance element, said variable reflectance element including a mirror with an electro-optic medium disposed between a first substrate and a second substrate, said first substrate contacting said electro-optic medium on its interior side, said second substrate having a metallic mirror reflector at its side contacted by said electro-optic medium, at least one light sensor and a control component which is responsive to a light level sensed by at least one light sensor, the mirror reflectance being adjustable by said component when the mirror assembly is operational and a display device mounted in said interior portion, said reflectance element overlying said display device, the mirror reflectance being controlled by said light sensor system, said display device being viewable by adjusting the reflectance of the variable reflectance element in response to the glare caused by the light beam of a rear traveling vehicle.

2. The mirror assembly of claim 1 wherein the mirror reflectance is controlled by either a manual adjustment, a manually settable switch or by the brightness value provided by said light sensor system.

3. The mirror assembly of claim 1 wherein said control circuit establishes a reflectance level of said reflective element responsive to a ratio of a glare light value to an ambient light value.

4. (canceled)

5. (canceled)

6. (canceled)

7. The mirror assembly of claim 1 wherein said assembly is positioned in a manner wherein said control circuit establishes said reflectance level within a relatively linear value of said ratio of glare light value to ambient light value to insure that information displayed in the display window is always visible to the driver of said vehicle.

8. The mirror assembly of claim 7 wherein the display device mounted in said interior portion is set to display a multitude of inputs viewing information important to the driver while limiting glare through the reflectance element.

9. (canceled)

10. A vehicle mirror assembly having a variable reflectance element, said reflectance element having a front surface and a rear surface, said front surface being viewable by a user, said reflectance element comprising a mirror reflector that partially reflects light incident thereon, an ambient light sensor system operable to sense ambient light, a glare light sensor system operable to sense light incident at or near said reflectance element, said glare light sensor converting incident light to a signal which is coupled to a microprocessor, said ambient light sensor converting incident light to a signal processed by said microprocessor, a control circuit operable to establish a reflectance level of said reflective element and responsive to light detected by said ambient light sensors and said glare light sensor; and wherein said control circuit establishes a reflectance level of said reflective element in response to a ratio of a glare light value to an ambient light value whereby information on said display device is always visible to the driver of said vehicle.

11. The mirror system of claim 10 wherein said control circuit establishes said reflectance level within a relatively linear value of said ratio of glare light value to said ambient light value.

12. The mirror assembly of claim 10 wherein said control circuit establishes a reflectance level of said reflective element in response to a ratio of a glare light value to said ambient light value.

13. (canceled)

14. (canceled)

15. The mirror assembly of claim 10 wherein said control circuit establishes said reflectance level within a relatively linear value of said ratio of glare light value to ambient light value to insure that information displayed in the display window is always visible to the driver of said vehicle.

16. The mirror assembly of claim 10 wherein the display device mounted in said interior portion can be set to display a multitude of inputs viewing information important to said user while limiting glare through the reflectance element.

17. The mirror assembly of claim 10 wherein the display device mounted in said interior portion can adjust the brightness of the display automatically depending on inputs from the said light sensor system.

18. A first vehicle having a self-adjusting mirror assembly having an interior portion and a variable reflectance element including a display monitor, the reflectance element and display monitor functioning together to keep the display visible in all lighting conditions while limiting the reflective light from a second vehicle traveling behind said first vehicle.

19. A self-adjusting mirror assembly of claim 18 including an electro-optic medium disposed between a first substrate and a second substrate, said first substrate contacting said electro-optic medium on its interior side, said second substrate having a metallic mirror reflector at its side contacted by said electro-optic medium, at least one light sensor and a control component which is responsive to a light level sensed by at least one light sensor to control mirror reflectance and monitor brightness.

20. The self-adjusting mirror assembly of claim 19 wherein the mirror reflectance is adjustable by said light sensor and a monitor mounted in said interior portion, said reflectance element overlying said monitor, the mirror reflectance being controlled by said light sensor system, said monitor being viewable by adjusting the reflectance of the monitor brightness and contrast enabling said monitor to be visible by the vehicle driver in substantially all light conditions.

21. The mirror assembly of claim 18 wherein the mirror reflectance is controlled by either a manual adjustment or a manually sellable switch.

22. The mirror assembly of claim 18 wherein said control circuit establishes a reflectance level of said reflective element responsive to a ratio of a glare light value to an ambient light value.

23. The mirror assembly of claim 18 wherein said control circuit establishes said reflectance level within a relatively linear value of the ratio of glare light value to ambient light value.

24. An electronic vehicle mirror assembly containing a variable reflectance element with an electro-optic medium disposed between a first substrate and a second substrate, said first substrate contacting said electro-optic medium on its interior side, said second substrate having a metallic mirror reflector at its side contacted by said electro-optic medium and a microprocessor controlled monitor for providing information to a vehicle driver, the monitor display being visible in substantially all types of lighting environments encountered by said driver.
